(19) United States
(12) Patent Application Publication
(10) Pub. No.: US 2025/0063601 A1
(43) Pub. Date: Feb. 20, 2025

(54) SIMULTANEOUS TRANSMISSION OF PEER-TO-PEER AND INFRASTRUCTURE TRAFFIC

(71) Applicant: Samsung Electronics Co., Ltd., Suwon-si (KR)

(72) Inventors: Vishnu Vardhan Ratnam, Plano, TX (US); Sagar Sudhakara, San Diego, CA (US); Rubayet Shafin, Frisco, TX (US); Boon Loong Ng, Plano, TX (US); Yue Qi, Plano, TX (US); Peshal Nayak, Plano, TX (US); Elliot Jen, Taipei City (TW)

(21) Appl. No.: 18/786,414

(22) Filed: Jul. 26, 2024

Related U.S. Application Data
(60) Provisional application No. 63/533,522, filed on Aug. 18, 2023.

(51) Int. Cl. H04W 74/0816; H04W 8/22; H04W 52/36; H04W 74/08

(52) U.S. Cl. CPC H04W 74/0816; H04W 8/22; H04W 52/367; H04W 74/0866

(57) ABSTRACT

Methods and apparatuses for simultaneous transmission of P2P and infrastructure traffic. A method of wireless communication performed by a first wireless device comprises: transmitting a message indicating a capability to support a simultaneous channel access transmission to a second wireless device; receiving, from the second wireless device, an indication for support of the simultaneous channel access transmission; negotiating parameters of coordination for the simultaneous channel access transmission with the second wireless device; performing coordinated channel access inside coordination windows for the simultaneous channel access transmission with the second wireless device; and performing uncoordinated channel access outside the coordination windows for non-simultaneous channel access transmission with the second wireless device.

### CROSS-REFERENCE TO RELATED APPLICATION(S) AND CLAIM OF PRIORITY

This application claims priority under 35 U.S.C. § 119(e) to U.S. Provisional Patent Application No. 63/533,522 filed on Aug. 18, 2023, which is hereby incorporated by reference in its entirety.

### TECHNICAL FIELD

This disclosure relates generally to wireless communications systems, and more particularly to methods and apparatus for simultaneous transmission of peer-to-peer (P2P) and infrastructure traffic.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

### SUMMARY

Embodiments of the present disclosure provide methods and apparatus for simultaneous transmission of P2P and infrastructure traffic.

In one embodiment, a method of wireless communication performed by a first wireless device comprises: transmitting a message indicating a capability to support a simultaneous channel access transmission to a second wireless device; receiving, from the second wireless device, an indication for support of the simultaneous channel access transmission; negotiating parameters of coordination for the simultaneous channel access transmission with the second wireless device; performing coordinated channel access inside coordination windows for the simultaneous channel access transmission with the second wireless device; and performing uncoordinated channel access outside the coordination windows for non-simultaneous channel access transmission with the second wireless device.

In another embodiment, a first wireless device comprises a transceiver, and a processor operably coupled to the transceiver. The processor is configured to: transmit a message indicating a capability to support a simultaneous channel access transmission to a second wireless device; receive, from the second wireless device, an indication for support of the simultaneous channel access transmission; negotiate parameters of coordination for the simultaneous channel access transmission with the second wireless device; perform coordinated channel access inside coordination windows for the simultaneous channel access transmission with the second wireless device; and perform uncoordinated channel access outside the coordination windows for non-simultaneous channel access transmission with the second wireless device.

In yet another embodiment, an access point (AP) associated with a second inter-connected network is provided, the AP comprising: a transceiver; and a processor operably coupled to the transceiver. The processor is configured to: receive a message indicating a capability to support a simultaneous channel access transmission from a first wireless device, wherein the first wireless device is a member of a first inter-connected network; transmit, to the first wireless device, an indication for support of the simultaneous channel access transmission; negotiate parameters of coordination for the simultaneous channel access transmission with the first wireless device; perform coordinated channel access inside coordination windows for the simultaneous channel access transmission with the first wireless device; and perform uncoordinated channel access outside the coordination windows for non-simultaneous channel access transmission with the first wireless device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example of infrastructure traffic being throttled by rising P2P traffic according to embodiments of the present disclosure;

FIG. 4 illustrates an example of the infrastructure and P2P nodes for an example scenario with M=3 STAs according to embodiments of the present disclosure;

FIG. 5 illustrates an example of coordination windows for simultaneous channel access by infrastructure and P2P traffic according to embodiments of the present disclosure;

FIG. 6 illustrates an example format of the capability indication for supporting simultaneous infrastructure and P2P transmission according to embodiments of the present disclosure;

FIG. 7 illustrates an example of the P2P Coordination Parameters element according to embodiments of the present disclosure;

FIG. 8 illustrates an example of the P2P Simultaneous Tx Setup frame according to embodiments of the present disclosure;

FIG. 9 illustrates an example of the TWT element with P2P Coordination Parameters as an optional subfield according to embodiments of the present disclosure;

FIG. 10 illustrates an example of the MU-RTS TXS trigger frame with the proposed subfields that contain parameters for the simultaneous transmission of P2P traffic with infrastructure traffic according to embodiments of the present disclosure;

FIG. 11 illustrates an example of the P2P Simultaneous Tx Teardown frame according to embodiments of the present disclosure;

FIG. 12 illustrates an example flow diagram illustrating the sequence of steps performed by an AP for enabling simultaneous transmission with P2P traffic according to embodiments of the present disclosure;

FIG. 13 illustrates an example flow diagram illustrating the sequence of steps performed by a non-AP STA (that is a P2P leader) to negotiate for the simultaneous transmissions of its P2P traffic with the infrastructure traffic according to embodiments of the present disclosure; and

FIG. 14 illustrates an example of a flow diagram illustrating a method for wireless communication performed by a first wireless device according to embodiments of the present disclosure.

### DETAILED DESCRIPTION

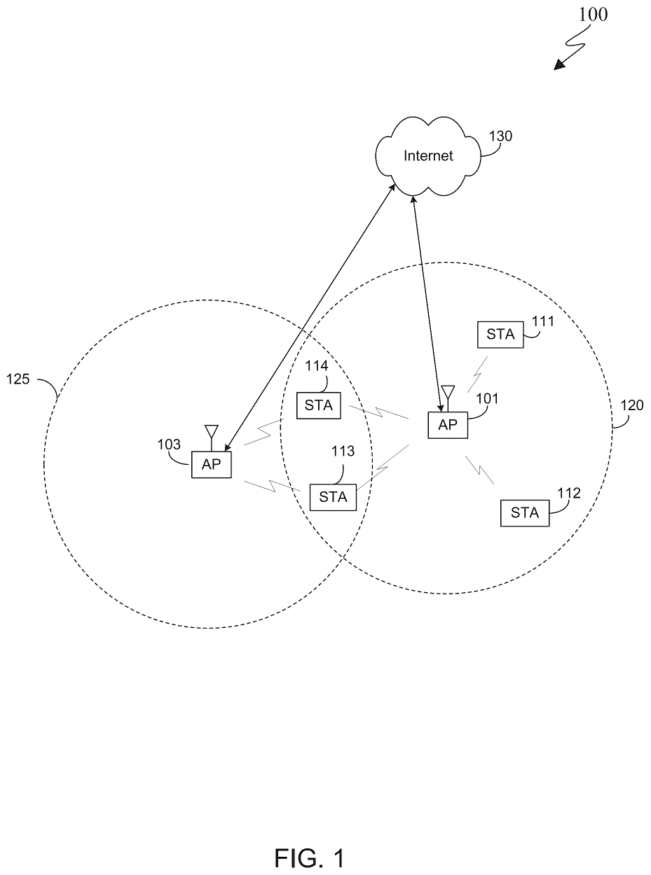

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein: [1]J. Yang, L. Yuan, C. Dong, G. Cheng, N. Ansari and N. Kato, “On Characterizing Peer-to-Peer Streaming Traffic,” in IEEE Journal on Selected Areas in Communications, vol. 31, no. 9, pp. 175-188, September 2013, doi: 10.1109/JSAC.2013.SUP.0513016; [2] WiFi Aware Networking Specification from WiFi Alliance—Draft 15; [3] Gil Reiter, “Wireless connectivity for the Internet of Things” White paper published by Texas Instruments; [4] ZigBee Alliance, “ZigBee specification” Document 05-3474-21, 2015; [5]“IEEE Standard for information technology—telecommunications and information exchange between systems—local and metropolitan area networks—specific requirements—part 11: Wireless LAN medium access control (MAC) and physical layer (PHY) specifications,” IEEE Std 802.11-2020 (Revision of IEEE Std 802.11-2016), pp. 1-4379, 2021; [6]“IEEE standard for information technology—telecommunications and information exchange between systems local and metropolitan area networks—specific requirements part 11: Wireless LAN medium access control (MAC) and physical layer (PHY) specifications amendment 1: Enhancements for high-efficiency WLAN,” IEEE Std 802.11 ax-2021 (Amendment to IEEE Std 802.11-2020), pp. 1-767, 2021; [7] IEEE P802.11be/D4.0—Draft Standard for Information technology—telecommunications and information exchange between systems local and metropolitan area networks—specific requirements part 11: Wireless LAN medium access control (MAC) and physical layer (PHY) specifications amendment 8: Enhancements for extremely high throughput (EHT),” IEEE Std 802.11be-2023 (Amendment to IEEE Std 802.11-REVme/D3.0), pp. 1-1055, 2023.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating simultaneous transmission of P2P and infrastructure traffic. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

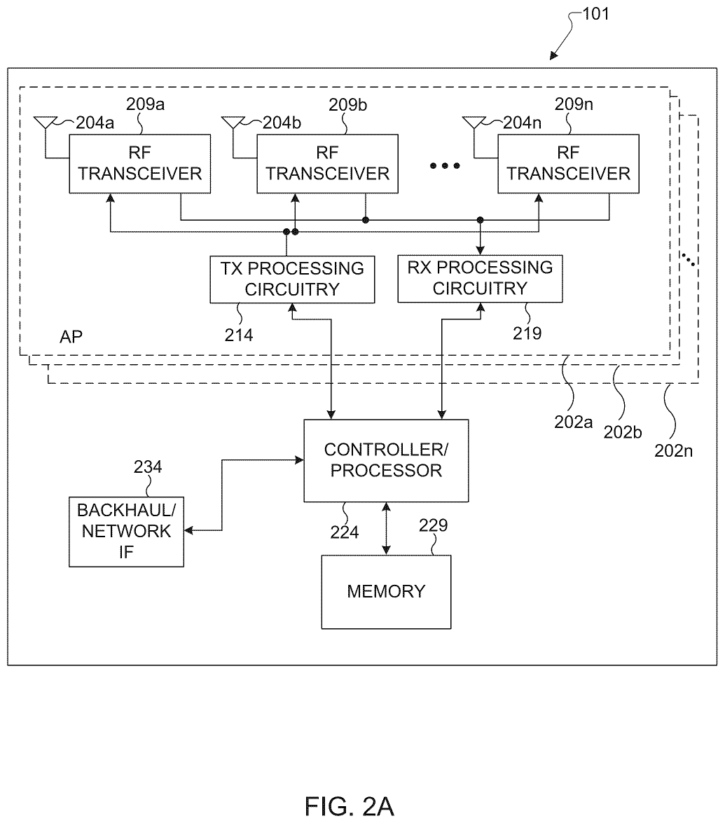

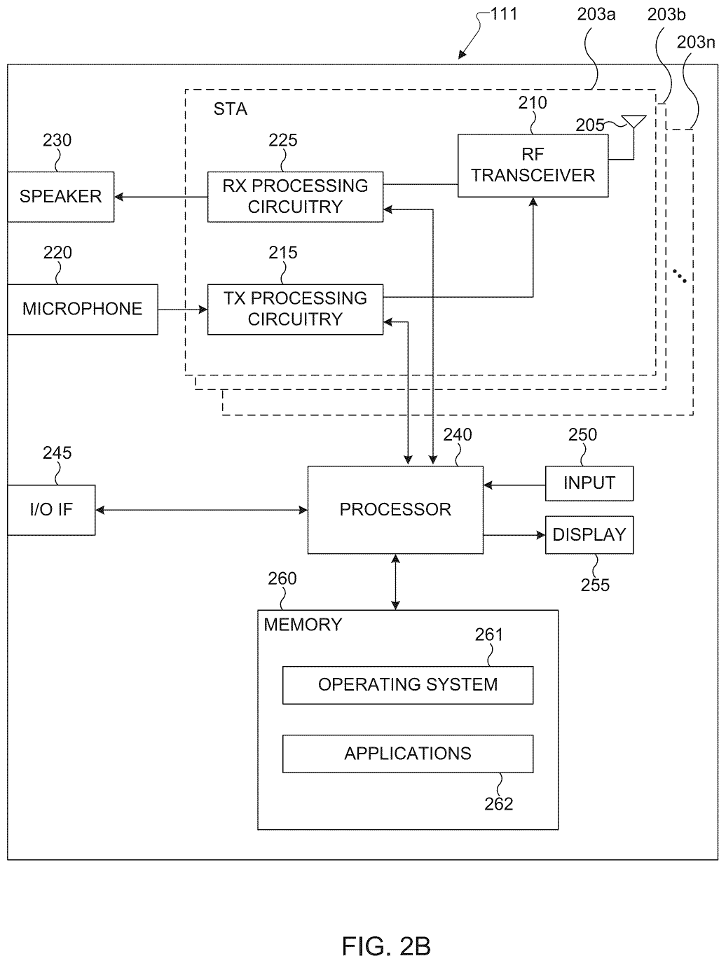

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating simultaneous transmission of P2P and infrastructure traffic. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for facilitating simultaneous transmission of P2P and infrastructure traffic. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to facilitate simultaneous transmission of P2P and infrastructure traffic. In some embodiments, the processor 240 includes at least one microprocessor or microcontroller.

The processor 240 is also capable of executing other processes and programs resident in the memory 260, such as operations for facilitating simultaneous transmission of P2P and infrastructure traffic. The processor 240 can move data into or out of the memory 260 as required by an executing process. In some embodiments, the processor 240 is configured to execute a plurality of applications 262, such as applications for facilitating simultaneous transmission of P2P and infrastructure traffic. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Various embodiments of the present disclosure recognize that the growth of P2P traffic in the future may strain infrastructure Wi-Fi networks, which share the same spectrum resources. This can cause both throughput and latency degradation for infrastructure networks.

Accordingly, various embodiments of the present disclosure propose a mechanism for simultaneous channel utilization (or non-orthogonal channel access) between infrastructure basic service set (BSS) operated by an access point (AP), and a P2P network within its coverage radius, both of which operate on the same bandwidth. Such a P2P network can also be a mobile AP network. Various embodiments of the present disclosure propose an algorithms for selection of the appropriate transmission parameters at the infrastructure network and the P2P network for enabling such simultaneous transmission.

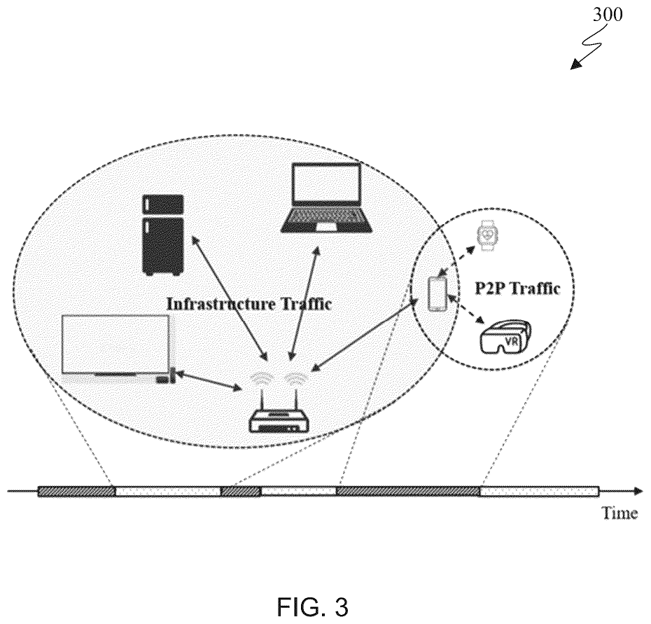

FIG. 3 illustrates an example of infrastructure traffic being throttled by rising P2P traffic 300 according to embodiments of the present disclosure. The embodiment of the example of infrastructure traffic being throttled by rising P2P traffic 300 shown in FIG. 3 is for illustration only. Other embodiments of the example of infrastructure traffic being throttled by rising P2P traffic 300 could be used without departing from the scope of this disclosure.

As illustrated in FIG. 3, the infrastructure Wi-Fi networks traffic and the P2P traffic share the same spectrum resources. This can cause both throughput and latency degradation for infrastructure networks.

Although the description below focuses on the coordination between an infrastructure BSS and a co-located P2P group with a P2P leader, this should not be construed as a limitation on the present disclosure. The proposed solutions are also equally applicable in cases where instead of a P2P group we have, for example:
another infrastructure BSS where the AP acts as the P2P leader;
a mobile AP BSS, where the mobile AP acts as the P2P leader etc.

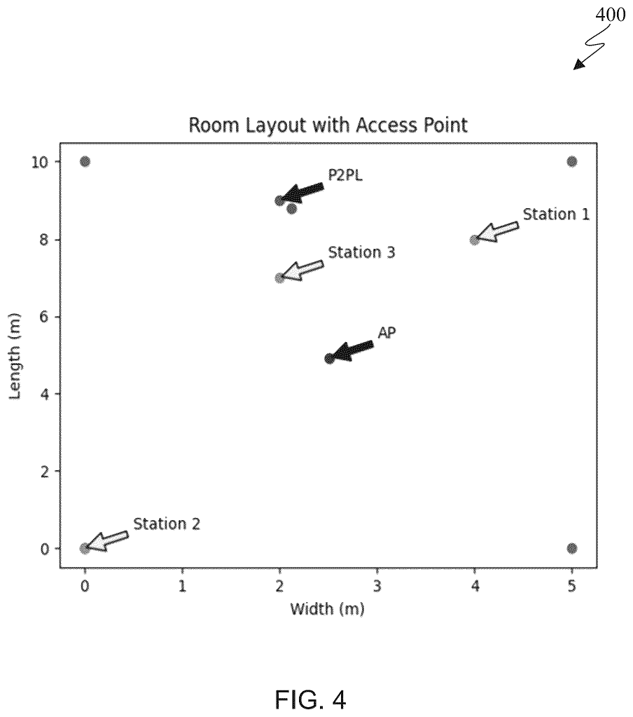

FIG. 4 illustrates an example of the infrastructure and P2P nodes for an example scenario with M=3 STAs 400 according to embodiments of the present disclosure. The embodiment of the example of the infrastructure and P2P nodes for an example scenario with M=3 STAs 400 shown in FIG. 4 is for illustration only. Other embodiments of the example of the infrastructure and P2P nodes for an example scenario with M=3 STAs 400 could be used without departing from the scope of this disclosure.

A scenario with an AP that has M STAs operating in its BSS is considered. It can be assumed that a P2P network is operating in the same geographical region as the AP's BSS, and that is operating on the same channel as the BSS. It can be assumed that the AP is aware of the existence of the P2P network and its traffic needs. This is achieved by a representative P2P device, called a P2P Leader (P2PL) being associated with the AP. Such a P2PL can be the NAN-leader in the case of Wi-Fi Aware, or a mobile AP in the case of mobile AP BSS. For convenience we assume the P2P network has only the P2PL and one other P2P STA.

Let us define the pathloss between any two nodes (i,j) in the network as: PL(i,j), where the AP has node index 0, the M STAs have indices 1, . . . , M, the P2PL has a node index M+1 and the P2P STA has a node index M+2. We assume that the AP is aware of the pathloss between it and every other associated device, i.e., it knows PL(0,j) for j={1, . . . , M+1}. We assume that the AP is also aware of its maximum transmit power P_{Tx,max}^{AP}, and the maximum transmit power of any STA P_{Tx,max}^{STA} In one embodiment, using the channel state information (CSI) measured from a packet sent from any of the associated STAs, the AP may also have knowledge of the azimuth angle θₘ of the line-of-sight path from it to each associated STA m.

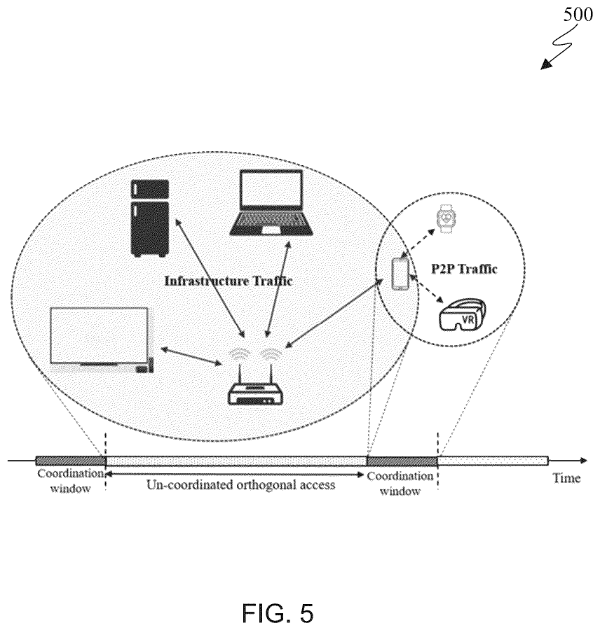

FIG. 5 illustrates an example of coordination windows for simultaneous channel access by infrastructure and P2P traffic 500 according to embodiments of the present disclosure. The embodiment of the example of coordination windows for simultaneous channel access by infrastructure and P2P traffic 500 shown in FIG. 5 is for illustration only. Other embodiments of the example of coordination windows for simultaneous channel access by infrastructure and P2P traffic 500 could be used without departing from the scope of this disclosure.

To improve the performance of both the infrastructure and P2P traffic, the AP and the P2PL may collaborate to enable simultaneous transmission of infrastructure and P2P traffic over the same time-frequency resources. These simultaneous transmissions may take place during specific coordination windows as depicted in FIG. 5. Outside of these coordination windows, un-coordinated orthogonal access may be performed by the infrastructure and P2P devices, as per the baseline specification. The transmissions during the coordination windows may be performed as per one of three options:
Option 1: The P2P nodes transmit within the window without constraints, and the infrastructure nodes opportunistically access the channel while limiting interference generated to the P2P traffic.
Option 2: The infrastructure nodes transmit within the window without constraints, and the P2P nodes opportunistically access the channel while limiting interference generated to the infrastructure traffic.
Option 3: Both the P2P nodes and infrastructure nodes may perform constrained transmissions within the coordination windows.

This collaboration may be beneficial for the P2P network since the AP may help the P2P network achieve more channel access opportunities than is possible without collaboration. This collaboration may be beneficial for the AP network since a significant portion of the P2P traffic may be transmitted via simultaneous transmission, thus reducing the channel contention that is faced by the infrastructure traffic. The coordination may happen in 4 steps:

### Step 1: Capability Indication

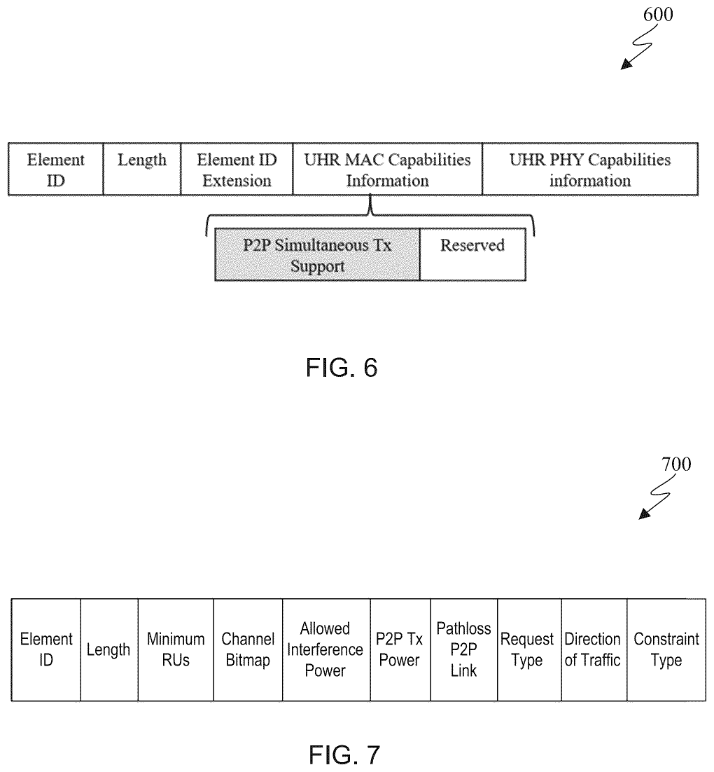

FIG. 6 illustrates an example format of the capability indication for supporting simultaneous infrastructure and P2P transmission 600 according to embodiments of the present disclosure. The embodiment of the example format of the capability indication for supporting simultaneous infrastructure and P2P transmission 600 shown in FIG. 6 is for illustration only. Other embodiments of the example format of the capability indication for supporting simultaneous infrastructure and P2P transmission 600 could be used without departing from the scope of this disclosure.

In one embodiment, the AP can indicate the capability to support P2P transmission with simultaneous channel access by setting a capability bit to 1 in the UHR Capabilities element that it transmits in beacons, probe response and association response frames. The bit can be called, for example, P2P Simultaneous Tx Support bit. For example, this UHR Capabilities element can be as depicted in FIG. 6. In a variant of this embodiment, the capability indication can be separate for each of Options 1, 2 and 3 described above.

In one embodiment, the P2PL STA can indicate the capability to support AP-assisted P2P transmissions with simultaneous channel access group by setting a capability bit to 1 in the UHR Capabilities element that it transmits in the probe request and association response frames. The bit can be called, for example, P2P Simultaneous Tx Support bit. In a variant of this embodiment, the capability indication can be separate for each of Options 1, 2 and 3 described above.

In one embodiment, the AP and P2PL STA, respectively, may negotiate for simultaneous channel access only if both the devices have indicated support for this capability in their respective UHR Capabilities elements.

### Step 2: Negotiation

In one embodiment, the P2PL can transmit a frame to the AP to negotiate the frequency of the coordination windows and the parameters for simultaneous use of a TXOP during a coordination window. The frame can contain an indication of one or more of:
An identifier for the negotiation being performed. This identifier can be, for example, a 1-octet Dialog Token field or a 3-bit TWT Flow Identifier field or a 5-bit Broadcast TWT ID carried in a TWT element.
An indication of the type of coordination requested: Option 1, 2 or 3. This indication can be carried in, for example, a 3-bit Request Type field.
The required periodicity of channel access for P2P traffic. This indication can, for example, be in units of transmit units (TUs) of 256 μs, and can be carried in a TWT element.
The required duration of each channel access for P2P traffic. This indication can, for example, be in units of transmit units (TUs) and can be carried in TWT Wake Interval Exponent and TWT Wake Interval Mantissa fields.
The required resource units (RUs) for the P2P transmission along with the RU indices. For example, this can be carried in a 1 octet Channel Bitmap field.
A metric indicating the pathloss of the P2P link that may communicate during the channel access. This can be carried, for example, in a 1 octet Pathloss P2P link field where a value of x can indicate a pathloss of 2xdB.
A metric indicating the intended transmit power of the P2PL and/or other P2P STAs. This can be carried, for example, in a P2P Tx Power field of length 6 bits and the units can be in units of dBm/20 MHz and if the field is set to a value of Fᵥₐₗ, the intended transmit power for P2P traffic is calculated as P_{TX}=−20+Fᵥₐₗ dBm/20 MHz.
A metric indicating the interference level that can be tolerated by the P2P receiver during the channel access, or a metric indicating the maximum permissible transmit power at the AP that can be tolerated by P2P receiver. This can be carried, for example, in a Allowed Interference Power field of length 6 bits and the units can be in units of dBm/20 MHz and if the field is set to a value of I, the allowed transmit power for P2P traffic is calculated as P_{TX}=−20+I dBm/20 MHz.
An indication of whether the indicated interference level is an average constraint or a worst-case constraint. This indication can be carried, for example, in a 2 bit Constraint Type field.
An indication of whether the reuse can be used only for DL, UL or bidirectional traffic by the AP. This can be carried, for example, in a Direction of Traffic field of length 2 bits.
An indication of link ID(s) of the operating link(s) for which the negotiation is applicable. This can be carried, for example, in a 4-bit Link ID field or a 16-bit Link ID Bitmap field.
An indication of the modulation and coding scheme that the P2P intends to use during the coordination window. This indication can be carried in, for example, a MCS field of size 4-bits.

In one embodiment, the AP may transmit a response frame to the P2PL indicating an Acceptance or Rejection of the suggested parameters. In case of rejection, the AP may also indicate an alternative parameter set that can be acceptable to the AP. This indication can act as a guidance to the P2PL in future request frames transmitted. In the response frame, the AP may also indicate any constraints that the P2P transmission may have to follow during the coordination windows. The frame can contain an indication of or more of:
An identifier for the negotiation being performed. This field may be copied from the value received in the request frame.
An indication of the type of coordination: Option 1, 2 or 3.
An indication of the status code for the request: Accept, Reject, Alternate, etc.
A metric indicating the interference level that can be tolerated in the infrastructure BSS, as observed by the AP, or a metric indicating the maximum permissible transmit power by the P2P members. This can be carried, for example, in an Allowed P2P Tx Power field of length 6 bits and the units can be in units of dBm/20 MHz and if the field is set to a value of Fᵥₐₗ, the allowed transmit power for P2P traffic is calculated as P_{TX}=−20+Fᵥₐₗ dBm/20 MHz.
An indication of whether the reuse can be performed only on downlink (DL), uplink (UL) or bidirectional traffic in the infrastructure. This can be carried, for example, in a Direction of Traffic field of length 2 bits.
An indication of the type of infrastructure PPDUs over which the reuse can be performed by P2P, e.g., allowed over UHR PPDUs, allowed over specific TIDs (identified from the QoS Control field).
An indication of link ID(s) of the operating link(s) for which the negotiation is applicable. This can be carried, for example, in a 4-bit Link ID field or a 16-bit Link ID Bitmap field.
An indication of the modulation and coding scheme that the P2P should use during the coordination window. This indication can be carried in, for example, a MCS field of size 4-bits.
An indication of the modulation and coding scheme that the infrastructure traffic intends to use during the coordination window. This indication can be carried in, for example, a MCS field of size 4-bits.

In addition to the above, the frame may also contain a copy of all the fields present in the request frame sent by the P2PL, as a confirmation of the accepted coordination parameters. In one variant, the frame by the AP can be sent in an un-solicited way by the AP to the P2PL.

FIG. 7 illustrates an example of the P2P Coordination Parameters element 700 according to embodiments of the present disclosure. The embodiment of the example of the P2P Coordination Parameters element 700 shown in FIG. 7 is for illustration only. Other embodiments of the example of the P2P Coordination Parameters element 700 could be used without departing from the scope of this disclosure.

In any of the aforementioned options, to indicate the parameters for the simultaneous channel access, a new element can be defined called the P2P Coordination Parameters element. In one example, the format of this element can be as shown in FIG. 7.

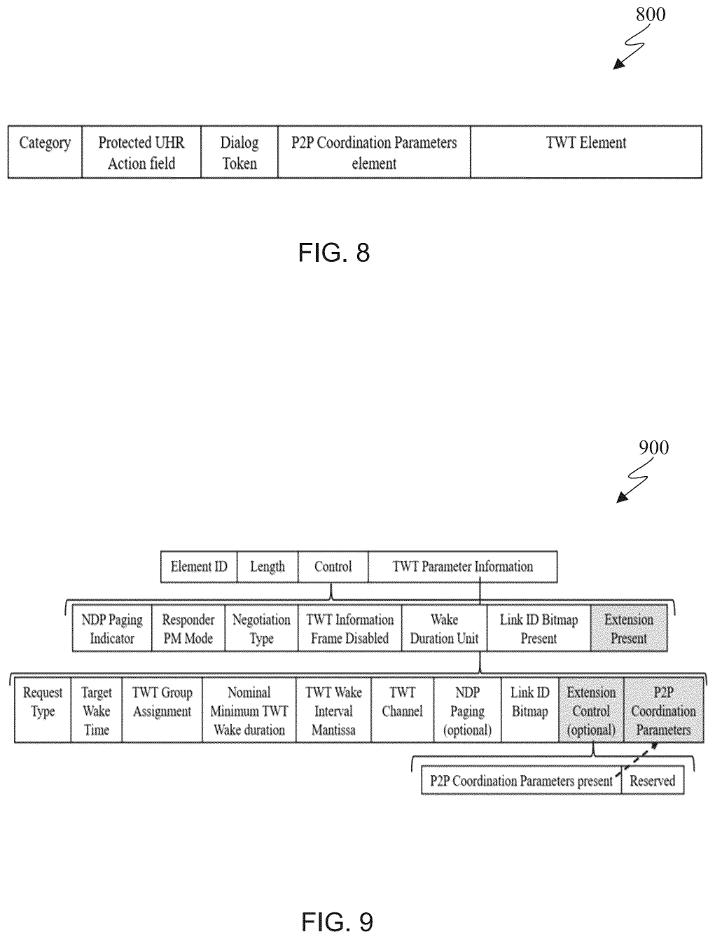

FIG. 8 illustrates an example of the P2P Simultaneous Tx Setup frame 800 according to embodiments of the present disclosure. The embodiment of the example of the P2P Simultaneous Tx Setup frame 800 shown in FIG. 8 is for illustration only. Other embodiments of the example of the P2P Simultaneous Tx Setup frame 800 could be used without departing from the scope of this disclosure.

In one embodiment, to negotiate the coordination parameters, the P2PL can transmit a new UHR Protected Action frame called P2P Simultaneous Tx Setup frame to an AP to negotiate the frequency of coordination windows and the parameters of coordination, as depicted in FIG. 8. This Action frame can have one or all of:
A Dialog Token field to identify each Setup frame sent by the P2PL. When responding to a Setup frame, the AP can use the same Dialog Token value as in the Setup frame to identify the request it is responding to.
A P2P Coordination Parameters element to indicate one or more of the coordination parameters discussed in Step 2.
A TWT element to negotiate a TWT corresponding to the coordination windows.

In one embodiment, the AP can send a P2P Simultaneous Tx Setup frame in response to indicate whether it accepts, rejects or suggests an alternative parameter set for use by the initiating P2PL. The indication of accept, reject, alternate etc. can be made using the TWT Setup Command field of the TWT Element. In one embodiment, if the indication is accept or reject, the P2P Coordination Parameters element may not be present in the response frame sent by the AP. In one embodiment involving option 2 or 3, the P2P Simultaneous Tx Setup frame sent by the AP in response to a P2P Simultaneous Tx Setup frame received from a P2PL may have additional fields like the Allowed P2P Tx Power field. In one embodiment, the P2P Coordination Parameters element can also be used in the TDLS Setup Request, TDLS Setup Response frames, and/or TWT Setup frames.

FIG. 9 illustrates an example of the TWT element with P2P Coordination Parameters as an optional subfield 900 according to embodiments of the present disclosure. The embodiment of the example of the TWT element with P2P Coordination Parameters as an optional subfield 900 shown in FIG. 9 is for illustration only. Other embodiments of the example of the TWT element with P2P Coordination Parameters as an optional subfield 900 could be used without departing from the scope of this disclosure.

In another embodiment, the P2PL can transmit a TWT Setup frame to an AP to negotiate the frequency of coordination windows and the parameters of coordination. In this case, the P2P Coordination Parameters element can be an optional subfield of the TWT element. There can be an additional bit in the Control field of the TWT element, called Extension Present. When this bit is set to 1, the TWT Parameter Information field can have an additional TWT Extension Control subfield of 8 or 16 bits as shown. One of the bits in the Extension Control subfield can be a P2P Coordination Parameters Present bit. When this bit is set to 1, the TWT Parameter Information can include a P2P Coordination Parameters element, as depicted in FIG. 9. In this embodiment, the AP may respond by sending a TWT Setup frame to the P2PL as a response indicating an accept, reject, or alternate parameter suggestion. In one embodiment involving option 2 or 3, the TWT Setup frame sent by the AP may have additional fields like the Allowed P2P Tx Power field, etc.

### Step 3: Initiating the Simultaneous Transmission

In option 1, during the coordination windows, the infrastructure nodes may perform opportunistic transmission over the P2P transmissions. In one variant of this embodiment, the simultaneous channel access by infrastructure can be performed over any P2P PPDUs detected during the coordination windows that satisfy the criteria negotiated in the Long-term negotiation. In another variant of this embodiment, the AP may explicitly transmit a frame indicating allocation of specific time and/or frequency resources for P2P transmission within the coordination windows. There may be one or more of the following features in such an explicit resource sharing frame:
An indication of the allocated time and resource units (RUs) for the P2P transmission. This indication can be carried in, for example, an 8-bit RU allocation field.
An indication about whether the allocated resources should only be used for P2P transmission, or they can also be used for uplink traffic with the AP. This indication can be carried in, for example, in a 2-bit Sharing Mode field.
An indication of the level of interference that will be generated by the infrastructure BSS during the shared resources. This can be used, for example, for MCS selection at the P2P devices and can be carried in a 6-bit Interference Power field, whose units can be dBm/20 MHz.
An indication of whether channel sensing needs to be performed by the P2P nodes before transmission.
An indication of the transmit power that the P2P nodes are allowed to use within the shared resources. This can be carried, for example, in an Allowed P2P Tx Power field of length 6 bits and the units can be in units of dBm/20 MHz and if the field is set to a value of Fᵥₐₗ, the allowed transmit power for P2P traffic is calculated as P_{TX}=−20+Fᵥₐₗ dBm/20 MHz.
An indication of the energy detection and/or preamble detection thresholds to be used by the P2P nodes for transmission.
An indication of the OBSS-PD threshold to be used by the P2P nodes during the coordination window.
An indication of the modulation and coding scheme that the P2P should use during the coordination window. This indication can be carried in, for example, a MCS field of size 4-bits.
An indication of the modulation and coding scheme that the infrastructure traffic intends to use during the coordination window. This indication can be carried in, for example, a MCS field of size 4-bits.

Some parameters may be negotiated in long-term negotiation but can be re-written by the explicit resource sharing frame.

The AP may refrain from transmitting infrastructure PPDUs within the coordination window to either the P2PL or any other STA that it knows is a member of the P2PL's P2P network.

In option 2, during the coordination windows, the P2P nodes may perform opportunistic transmission over the infrastructure transmissions. In one variant of this embodiment, the simultaneous channel access by the P2P nodes can be performed over any infrastructure PPDUs (corresponding to the AP's BSS) detected during the coordination windows that satisfy the criteria negotiated in the Long-term negotiation. In another variant of this embodiment, the AP may explicitly transmit a frame indicating allocation of specific time and/or frequency resources for P2P transmission within the coordination windows. There may be one or more of the following features in such an explicit resource sharing frame:
An indication of the allocated time and resource units (RUs) for the P2P transmission. This indication can be carried in, for example, an 8-bit RU allocation field.
An indication about whether the allocated resources should only be used for P2P transmission, or they can also be used for uplink traffic with the AP. This indication can be carried in, for example, in a 2-bit Sharing Mode field.
An indication of the level of interference that will be generated by the infrastructure BSS during the shared resources. This can be used, for example, for MCS selection at the P2P devices and can be carried in a 6-bit Interference Power field, whose units can be dBm/20 MHz.
An indication of whether channel sensing needs to be performed by the P2P nodes before transmission.
An indication of the transmit power that the P2P nodes are allowed to use within the shared resources. This can be carried, for example, in an Allowed P2P Tx Power field of length 6 bits and the units can be in units of dBm/20 MHz and if the field is set to a value of Fᵥₐₗ, the allowed transmit power for P2P traffic is calculated as P_{TX}=−20+Fᵥₐₗ dBm/20 MHz.
An indication of the energy detection and/or preamble detection thresholds to be used by the P2P nodes for transmission.
An indication of the OBSS-PD threshold to be used by the P2P nodes during the coordination window.
An indication of the modulation and coding scheme that the P2P should use during the coordination window. This indication can be carried in, for example, a MCS field of size 4-bits.
An indication of the modulation and coding scheme that the infrastructure traffic intends to use during the coordination window. This indication can be carried in, for example, a MCS field of size 4-bits.

Some parameters may be negotiated in long-term negotiation but can be re-written by the explicit resource sharing frame. The AP may refrain from transmitting infrastructure PPDUs within the coordination window to either the P2PL or any other STA that it knows is a member of the P2PL's P2P network.

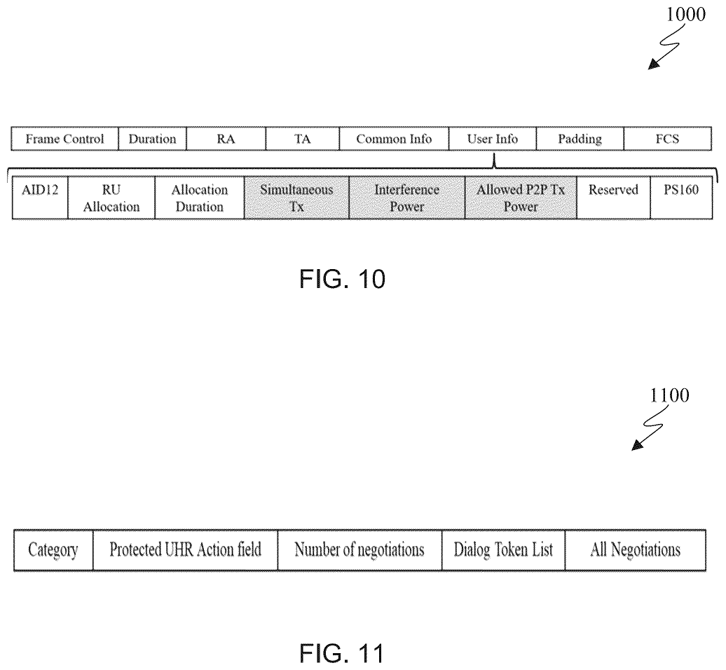

FIG. 10 illustrates an example of the MU-RTS TXS trigger frame with the proposed subfields that contain parameters for the simultaneous transmission of P2P traffic with infrastructure traffic 1000 according to embodiments of the present disclosure. The embodiment of the example of the MU-RTS TXS trigger frame with the proposed subfields that contain parameters for the simultaneous transmission of P2P traffic with infrastructure traffic 1000 shown in FIG. 10 is for illustration only. Other embodiments of the example of the MU-RTS TXS trigger frame with the proposed subfields that contain parameters for the simultaneous transmission of P2P traffic with infrastructure traffic 1000 could be used without departing from the scope of this disclosure.

In one example, the resource sharing frame can be a MU-RTS TXS Trigger frame. The AP may transmit a MU-RTS TXS Trigger frame to the P2PL to share resources for use by P2PL for traffic during the coordination windows. Such an MU-RTS TXS frame may have the following features:
In one variant, the Triggered TXOP Sharing Mode subfield may be set to 2. In another variant, the Triggered TXOP Sharing Mode can be set to 3 to indicate that the TXOP should only be used for P2P traffic and not for uplink traffic (since the AP will perform simultaneous transmission).
The User Info field corresponding to the P2PL can have a 1-bit subfield called Simultaneous Tx subfield. This bit is set to 1 by the transmitting AP to indicate that the shared TXOP will be used for simultaneous transmission by the AP (while respecting the rules negotiated in step 2).
The User Info field can have an Interference Power subfield indicating the level of interference that will be generated by the infrastructure BSS during the TXOP. For example, this subfield can be of length 6 bits and the units can be in units of dBm/20 MHz and can be encoded in 2's complement format for including negative numbers. In one variant, this subfield may be present only when TXOP Sharing Mode is set to 3 or if the Simultaneous Tx subfield is set to 1 in the Common Info field.
The User Info field may also have a P2P Tx Power subfield indicating the transmit power that will be allowed for the P2P transmissions during the TXOP. For example, this subfield can be of length 6 bits and the units can be in units of dBm/20 MHz and if the field is set to a value of Fᵥₐₗ, the allowed transmit power for P2P traffic is calculated as P_{TX}=−20+Fᵥₐₗ dBm/20 MHz. In one variant, this subfield may be present only when TXOP Sharing Mode is set to 3 or if the Simultaneous Tx subfield is set to 1 in the Common Info field.
   This example format of the MU-RTS TXS frame is depicted in FIG. 10.

### Step 4: Determining the Infrastructure and P2P Transmission Parameters [Option 1]

Note that in option 1, during the coordination windows, the infrastructure nodes may perform opportunistic transmission over the P2P transmissions. The max allowed interference level I that infrastructure is allowed to generate may be negotiated by the P2PL in Step 2 or 3.

In one embodiment, I can be selected by the P2PL to ensure that the P2P traffic can meet its highest desired MCS level. In another embodiment, the AP may perform an optimization problem to compute the best MCS level for use by the P2P traffic and infrastructure traffic within the coordination windows, and thus may suggest the appropriate value of I to be used. Such a determination can be, for example, based on the following algorithm for the case of downlink infrastructure transmission within the coordination windows:

```
Inputs: PL(0, m) for each associated STA m, P_{Tx,max}^{AP}, P_{Tx,max}^{STA}, N₀
// Here N₀ is the noise power.
// Estimation of the average modulation and coding scheme index
(MCS) in case of no interference
Calculate MCSₘₐₓ^{Infra} as the average MCS (averaged across all STAs)
achievable by downlink transmissions in case of no interference
from P2P and with AP transmitting with maximum power P_{Tx,max}^{AP}.
Calculate MCSₘₐₓ^{P2P} as the MCS average achievable by the P2P traffic
in case of no interference from infrastructure and P2P transmitting
with maximum power P_{Tx,max}^{STA}.
T = 0.
I_{old} = 0.
For μ^{P2P} = MCSₘₐₓ^{P2P}: (−1): 0
  Calculate I as the maximum allowed interference level at the P2PL
to ensure MCS μ^{P2P} for the P2P link.
  Calculate P_{Tx}^{AP} as maximum allowed TX power at the
infrastructure to ensure interference level ≤ I for the P2P link
P2P link.
  Calculate μ^{AP} as the achievable MCS (averaged across all
STAs) for the infrastructure transmission by the AP considering
the AP transmit power P_{Tx}^{AP} and full interference from the P2P.
  $If \frac{{μ}^{A P}}{M C {S}_{max}^{Infra}} + \frac{{μ}^{P 2 P}}{M C {S}_{max}^{P 2 P}} < T$
    Return I_{old};
  EndIf
  $T = \frac{{μ}^{AP}}{{MCS}_{max}^{Infra}} + \frac{{μ}^{P 2 P}}{{MCS}_{max}^{P 2 P}} .$
  I_{old} = I.
endFor
Return l_{old}.
```

In a variant of this algorithm instead of computing the average values across all the STAs, the values can be computed assuming the downlink transmission is only performed to STA m̅ where:

$$\overline{m} = {argmax}_{m ∈ \{ 1 , … , M \}} \{ \hat{PL} ( m , M + 1 ) - P L ( 0 , m ) \} ,$$

where the computation of [symbol] (·) is described below.

Similarly for the uplink case, the determination can be made, for example, based on the following algorithm:

```
Inputs: PL(0, m) for each associated STA m, P_{Tx,max}^{AP}, P_{Tx,max}^{STA}, N₀
// Here N₀ is the noise power.
// Estimation of the average modulation and coding scheme index
(MCS) in case of no interference
Calculate MCSₘₐₓ^{Infra} as the average MCS (averaged across all STAs)
achievable by downlink transmissions in case of no interference
from P2P and with STA transmitting with maximum power P_{Tx,max}^{STA}.
Calculate MCSₘₐₓ^{P2P} as the MCS average achievable by the P2P traffic
in case of no interference from infrastructure and P2P transmitting
with maximum power P_{Tx,max}^{STA}.
T = 0.
I_{old} = 0.
For μ^{P2P} = MCSₘₐₓ^{P2P}: (−1): 0
  Calculate I as the maximum allowed interference level at the
P2PL to ensure MCS μ^{P2P} for the P2P link.
  Calculate P_{Tx}^{STA} as maximum allowed TX power at the
infrastructure to ensure interference level ≤ I for the P2P link
P2P link.
  Calculate μ^{AP} as the achievable MCS (averaged across all
STAs) for the infrastructure transmission by the AP considering
the STA transmit power P_{Tx}^{STA} and full interference from the P2P.
  $If \frac{{μ}^{A P}}{M C {S}_{max}^{Infra}} + \frac{{μ}^{P 2 P}}{M C {S}_{max}^{P 2 P}} < T$
    Return I_{old};
  EndIf
  $T = \frac{{μ}^{AP}}{{MCS}_{max}^{Infra}} + \frac{{μ}^{P 2 P}}{{MCS}_{max}^{P 2 P}} .$
  I_{old} = I.
endFor
Return l_{old}.
```

In a variant of this algorithm instead of computing the average values across all the STAs, the values can be computed assuming the uplink transmission is only performed by STA m̅ where:

$$\overline{m} = {argmax}_{m ∈ \{ 1 , … , M \}} \{ \hat{PL} ( m , M + 1 ) - P L ( 0 , m ) \} ,$$

where the computation of [symbol] (·) is described below.

Using the max allowed interference level indication I, the AP can determine the max transmit power it can use during the coordination period for simultaneous access. Using the other information shared, the AP can also determine the max uplink transmit power each STA can use during the coordination period for simultaneous access. Although, pathloss between (AP, P2P STA) and between (P2PL, P2P STA) are unknown to the AP, they can be estimated based on the information shared by the P2PL in the negotiation phase. AP can then intelligently select the STA to serve and whether to perform uplink or downlink transmissions during simultaneous access. Detailed embodiments for such calculation are shared below:

In one embodiment, the AP may not have azimuth angle information θₘ and it may intend to perform downlink transmission during a coordination period. In this case, the AP needs to ensure that the interference power generated at the P2PL is below I dBm. Here the value of I can be the negotiated interference level selected in either of Step 2 or Step 3. In one example, the AP, since it knows the pathloss from AP to P2PL, it can determine allowed AP TX power as:

$${P}_{T x}^{A P} = min \{ I + PL ( 0 , M + 1 ) , {P}_{Tx , max}^{A P} \}$$

For selecting the recipient of the downlink transmission, the AP may select the STA m* that can achieve the highest signal to interference ratio. Although the pathloss between a STA m to the P2PL: PL(m, M+1) is unknown at the AP, the AP can infer the distance of each STA from it using the pathloss to the AP. Using this, the AP can compute the worst case pathloss between a STA and P2PL can be estimate as:

$$\hat{PL} ( m , M + 1 ) = 20 {log}_{10} \vert 10 \frac{P L ( 0 , M + 1 )}{20} - 1 {0}^{\frac{P L ( 0 , m )}{20}} \vert , for$$

$$m ∈ \{ 1 , … , M \} .$$

It can then select the best STA to be served for downlink transmission as:

$${m}^{*} = {argmax}_{m ∈ \{ 1 , … , M \}} \{ {P}_{T x}^{A P} - P L ( 0 , m ) + \hat{PL} ( m , M + 1 ) \} = \\ {argmax}_{m ∈ \{ 1 , … , M \}} [ min \{ I + PL ( 0 , M + 1 ) , {P}_{Tx , max}^{A P} \} - P L ( 0 , m ) + \hat{PL} ( m , M + 1 ) ]$$

In one embodiment, the AP may have azimuth angle information Om and it may intend to perform downlink transmission during a coordination period. In this case, the AP needs to ensure that the interference power generated at the P2PL is below I dBm. Here the value of I can be the negotiated interference level selected in either of Step 2 or Step 3. In one example, the AP, since knows the pathloss from AP to P2PL, it can determine allowed AP TX power as:

$${P}_{T x}^{A P} = min \{ I + PL ( 0 , M + 1 ) , {P}_{Tx , max}^{A P} \}$$

For selecting the recipient of the downlink transmission, the AP may select the STA m* that can achieve the highest signal to interference ratio. Although the pathloss between a STA m to the P2PL: PL(m, M+1) is unknown at the AP, the AP can infer the distance of each STA from it using the pathloss to the AP. It is also aware of the azimuth angle between the two devices as θₘ−θ_{M+1}. Using this, the AP can compute the pathloss between a STA and P2PL can be estimate as:

$$\hat{PL} ( m , M + 1 ) = 10 {log}_{10} ( \vert 10 \frac{P L ( 0 , M + 1 )}{20} - 1 {0}^{\frac{P L ( 0 , m )}{20}} cos ( {θ}_{m} - {θ}_{M + 1} ) {\vert}^{2} + \vert {10}^{\frac{P L ( 0 , m )}{20}} sin ( {θ}_{m} - {θ}_{M + 1} ) {\vert}^{2} ) .$$

It can then select the best STA to be served for downlink transmission as:

$${m}^{*} = {argmax}_{m ∈ \{ 1 , … , M \}} \{ {P}_{T x}^{A P} - P L ( 0 , m ) + \hat{PL} ( m , M + 1 ) \} = \\ {argmax}_{m ∈ \{ 1 , … , M \}} [ min \{ I + PL ( 0 , M + 1 ) , {P}_{Tx , max}^{A P} \} - P L ( 0 , m ) + \hat{PL} ( m , M + 1 ) ]$$

In one embodiment, the AP may not have azimuth angle information Om and it may intend to perform uplink transmission during a coordination period. In this case, the AP needs to ensure that the interference power generated at the P2PL by uplink transmission from the transmitting STA m is below I dBm. Here the value of I can be the negotiated interference level selected in either of Step 2 or Step 3. Although the pathloss between a STA m to the P2PL: PL(m, M+1) is unknown at the AP, the AP can infer the distance of each STA from it using the pathloss to the AP. Using this, the AP can compute the worst case pathloss between a STA and P2PL can be estimate as:

$$\hat{PL} ( m , M + 1 ) = 20 {log}_{10} \vert 10 \frac{P L ( 0 , M + 1 )}{20} - 1 {0}^{\frac{P L ( 0 , m )}{20}} \vert , for$$

$$m ∈ \{ 1 , … , M \} .$$

Then the allowed transmit power at STA m is calculated as:

$${P}_{Tx}^{STA m} = min \{ I + \hat{PL} ( m , M + 1 ) , {P}_{Tx , max}^{STA} \}$$

It can then select the best STA for uplink transmission as:

$$\begin{matrix}{m}^{*} = {arg max}_{m ∈ \{ 1 , … , M \}} \{ {P}_{Tx}^{STA m} - PL ( 0 , m ) + PL ( 0 , M + 1 ) \} \\ = {arg max}_{m ∈ \{ 1 , … , M \}} [ min \{ I + \hat{PL} ( m , M + 1 ) , {P}_{Tx , max}^{STA} \} - PL ( 0 , m ) + PL ( 0 , M + 1 ) ]\end{matrix}$$

In one embodiment, the AP may have azimuth angle information θₘ and it may intend to perform uplink transmission during a coordination period. In this case, the AP needs to ensure that the interference power generated at the P2PL by uplink transmission from the transmitting STA m is below I dBm. Here the value of I can be the negotiated interference level selected in either of Step 2 or Step 3. Although the pathloss between a STA m to the P2PL: PL(m, M+1) is unknown at the AP, the AP can infer the distance of each STA from it using the pathloss to the AP. It is also aware of the azimuth angle between the two devices as θₘ−θ_{M+1}. Using this, the AP can compute the worst case pathloss between a STA and P2PL can be estimate as:

$$\hat{PL} ( m , M + 1 ) = 10 {log}_{10} ( \text{} {\vert 10 \frac{PL ( 0 , M + 1 )}{20} - 1 {0}^{\frac{PL ( 0 , m )}{20}} cos ( {θ}_{m} - {θ}_{M + 1} ) \vert}^{2} + {\vert {10}^{\frac{PL ( 0 , m )}{20}} sin ( {θ}_{m} - {θ}_{M + 1} ) \vert}^{2} ) .$$

Then the allowed transmit power at STA m is calculated as:

$${P}_{Tx}^{STA m} = min \{ I + \hat{PL} ( m , M + 1 ) , {P}_{Tx , max}^{STA} \}$$

It can then select the best STA for uplink transmission as:

$$\begin{matrix}{m}^{*} = {arg max}_{m ∈ \{ 1 , … , M \}} \{ {P}_{Tx}^{STA m} - PL ( 0 , m ) + PL ( 0 , M + 1 ) \} \\ = {arg max}_{m ∈ \{ 1 , … , M \}} [ min \{ I + \hat{PL} ( m , M + 1 ) , {P}_{Tx , max}^{STA} \} - PL ( 0 , m ) + PL ( 0 , M + 1 ) ]\end{matrix}$$

The user selection may further consider other aspects like the priority of their traffic, availability of buffered traffic, the STA being in awake state, etc. In one example, it may be assumed that pathloss to P2PL is similar to the pathloss to the P2P STAs since they are co-located, i.e., PL(m, M+1)≈PL(m, M+2) for m∈{0,1, . . . , M}.

In one embodiment, the AP may determine whether to perform uplink infrastructure transmission or downlink infrastructure transmission during the coordination window based on which of the two can achieve the higher throughput. For example, the AP may determine the best STA m₁ for downlink transmission and the best STA m₂ for uplink transmission. It may then perform downlink transmission to STA m₁ if:

$$min \{ I + PL ( 0 , M + 1 ) , {P}_{Tx , max}^{AP} \} - PL ( 0 , {m}_{1} ) + \hat{PL} ( {m}_{1} , M + 1 ) \geq min \{ I + \hat{PL} ( {m}_{2} , M + 1 ) , {P}_{Tx , max}^{STA} \} - PL ( 0 , {m}_{2} ) + PL ( 0 , M + 1 )$$

If the condition is not satisfied, the AP may perform uplink transmission to STA m₂.

In yet another embodiment, the AP may also verify if the infrastructure transmission can achieve the minimum signal-to-interference ratio required to support a minimum required modulation and coding scheme (MCS). If it can't support the minimum MCS, the AP may refrain from initiating infrastructure transmission during the coordination window or may refrain from sharing resource with the P2PL.

### Step 4: Determining the Infrastructure and P2P Transmission Parameters [Option 2]

Note that in option 2, during the coordination windows, the P2P nodes may perform opportunistic transmission over the infrastructure transmissions. In option 2, the AP may indicate, either in step 2 or 3, the maximum transmit power P_{Tx}^{P2P} that P2P STAs are allowed to use during a coordination window.

In one embodiment, the AP may make this determination such that the scheduled infrastructure transmission during the coordination window (either uplink or downlink), may meet a desired MCS level. In another embodiment, the AP may perform an optimization problem to compute the best MCS level for use by the P2P traffic and infrastructure traffic within the coordination windows, and thus may suggest the appropriate value of P_{Tx}^{P2P} to be used. Such a determination can be, for example, based on the following algorithm for the case of downlink infrastructure transmission within the coordination windows:

```
Inputs: PL(0, m) for each associated STA m, P_{Tx,max}^{AP}, P_{Tx,max}^{STA}, N₀
// Here N₀ is the noise power.
// Estimation of the average modulation and coding scheme index
(MCS) in case of no interference
Calculate MCSₘₐₓ^{Infra} as the average MCS (averaged across all STAs)
achievable by downlink transmissions in case of no interference
from P2P and with AP transmitting with maximum power P_{Tx,max}^{AP}.
Calculate MCSₘₐₓ^{P2P} as the MCS average achievable by the P2P traffic
in case of no interference from infrastructure and P2P transmitting
with maximum power P_{Tx,max}^{STA}.
T = 0.
${P}_{{T}_{x}}^{P 2 P} = - 100 .$
For μ^{AP} = MCSₘₐₓ^{Infra}: (−1): 0
  Calculate P_{Tx,new}^{P2P} as the maximum allowed TX power at the
P2PL to ensure the AP can on average achieve an MCS of μ^{AP} for
any associated STA.
  Calculate μ^{P2P} as the achievable MCS for the P2P traffic
considering the P2P uses a transmit power P_{Tx,new}^{P2P} and full
interference from the AP.
  $If \frac{{μ}^{A P}}{M C {S}_{max}^{Infra}} + \frac{{μ}^{P 2 P}}{M C {S}_{max}^{P 2 P}} < T$
      Return P_{Tx}^{P2P};
  EndIf
  $T = \frac{{μ}^{AP}}{{MCS}_{max}^{Infra}} + \frac{{μ}^{P 2 P}}{{MCS}_{max}^{P 2 P}} .$
  P_{Tx}^{P2P} = P_{Tx,new}^{P2P}.
endFor
Return P_{Tx}^{P2P}.
```

In a variant of this algorithm instead of computing the average values across all the STAs, the values can be computed assuming the downlink transmission is only performed to STA m where:

$$\overline{m} = {arg max}_{m ∈ \{ 1 , … , M \}} \{ \hat{PL} ( m , M + 1 ) - PL ( 0 , m ) \} ,$$

where the computation of [symbol] (·) is described below.

Similarly for the uplink case, the determination can be made, for example, based on the following algorithm:

```
Inputs: PL(0, m) for each associated STA m, P_{Tx,max}^{AP}, P_{Tx,max}^{STA}, N₀
// Here N₀ is the noise power.
// Estimation of the average modulation and coding scheme index
(MCS) in case of no interference
Calculate MCSₘₐₓ^{Infra} as the average MCS (averaged across all STAs)
achievable by downlink transmissions in case of no interference
from P2P and with STA transmitting with maximum power P_{Tx,max}^{STA}.
Calculate MCSₘₐₓ^{P2P} as the MCS average achievable by the P2P traffic
in case of no interference from infrastructure and P2P transmitting
with maximum power P_{Tx,max}^{STA}.
T = 0.
${P}_{{T}_{x}}^{P 2 P} = - 100 .$
For μ^{AP} = MCSₘₐₓ^{Infra}: (−1): 0
  Calculate P_{Tx,new}^{P2P} as maximum allowed TX power at the P2PL
to ensure the uplink infrastructure transmissions to AP can on
average achieve an MCS of μ^{AP} for any associated STA.
  Calculate μ^{P2P} as the achievable MCS for the P2P traffic
considering the P2P uses a transmit power P_{Tx,new}^{P2P} and the
average full interference from any of the infrastructure STAs.
  $If \frac{{μ}^{A P}}{M C {S}_{max}^{Infra}} + \frac{{μ}^{P 2 P}}{M C {S}_{max}^{P 2 P}} < T$
      Return P_{Tx}^{P2P};
  EndIf
  $T = \frac{{μ}^{AP}}{{MCS}_{max}^{Infra}} + \frac{{μ}^{P 2 P}}{{MCS}_{max}^{P 2 P}} .$ ${P}_{T x}^{P2P} = {P}_{Tx , new}^{P2P} .$
endFor
Return P_{Tx}^{P2P}.
```

In a variant of this algorithm instead of computing the average values across all the STAs, the values can be computed assuming the uplink transmission is only performed by STA m̅ where:

$$\overline{m} = {arg max}_{m ∈ \{ 1 , … , M \}} \{ \hat{PL} ( m , M + 1 ) - PL ( 0 , m ) \} ,$$

where the computation of [symbol] (·) is described below.

In one embodiment, for a selected STA m to be served in downlink direction the AP may transmit at its maximum power P_{TX,max}^{AP}. The needed signal-to-interference ratio of SIR_{Infra} to meet the desired MCS, the limit on P2P transmit power can be:

$${P}_{Tx}^{P 2 P} ( m ) = min \{ {P}_{Tx , max}^{AP} - PL ( 0 , m ) + \hat{PL} ( m , M + 1 ) - {SIR}_{Infra} , {P}_{Tx , max}^{STA} \} .$$

The STA to be served m* may then be selected as the one that allows the highest P2P signal-to-interference ratio, i.e.,

$${m}^{*} = {arg max}_{m ∈ \{ 1 , … , M \}} \{ min \{ {P}_{Tx , max}^{AP} - PL ( 0 , m ) + \hat{PL} ( m , M + 1 ) - {SIR}_{Infra} , {P}_{Tx , max}^{STA} \} + PL ( 0 , M + 1 ) \} ,$$

and the allowed P2P transmit power can be set as: P_{Tx}^{P2P}=P_{Tx}^{P2P}(m*). Here the value of the estimated pathloss [symbol] (m, M+1) can be performed as in case of Option 1 above, depending on whether angle information θₘ is available or not. In a variant of this embodiment, the user selection may further consider other aspects like the priority of their traffic, availability of buffered traffic, the STA being in awake state, etc.

In one embodiment, for a selected STA m to be served in uplink direction, the STA may use its maximum transmit power P_{Tx,max}^{STA}. The needed signal-to-interference ratio of SIR_{Infra} to meet the desired MCS, the limit on the P2P transmit power can be:

$${P}_{Tx}^{P 2 P} ( m ) = min \{ {P}_{Tx , max}^{STA} - PL ( 0 , m ) + PL ( 0 , M + 1 ) - {SIR}_{Infra} , {P}_{Tx , max}^{STA} \} .$$

The STA to be served m* may then be selected as the one that allows the highest P2P signal-to-interference ratio, i.e.,

$${m}^{*} = {arg max}_{m ∈ \{ 1 , … , M \}} \{ min \{ {P}_{Tx , max}^{STA} - P L ( 0 , m ) + P L ( 0 , M + 1 ) - {SIR}_{Infra} , {P}_{Tx , max}^{STA} \} + \hat{PL} ( m , M + 1 ) \} ,$$

and the allowed P2P transmit power can be set as: P_{Tx}^{P2P}=P_{Tx}^{P2P}(m*). Here the value of the estimated pathloss PL(m, M+1) can be performed as in case of Option 1 above, depending on whether angle information θₘ is available or not. In a variant of this embodiment, the user selection may further consider other aspects like the priority of their traffic, availability of buffered traffic, the STA being in awake state, etc.

In one embodiment, the determination of performing uplink transmission or downlink transmission may be made based on which allows a larger P2P signal-to-interference ratio. For example, the AP may determine the best STA m₁ for downlink transmission and the best STA m₂ for uplink transmission. It may then perform downlink transmission to STA m₁ if:

$$min \{ {P}_{Tx , max}^{AP} - PL ( 0 , {m}_{1} ) + \hat{PL} ( {m}_{1} , M + 1 ) - {SIR}_{Infra} , {P}_{Tx , max}^{STA} \} + PL ( 0 , M + 1 ) \geq min \{ {P}_{Tx , max}^{STA} - PL ( 0 , {m}_{2} ) + PL ( 0 , M + 1 ) - {SIR}_{Infra} , {P}_{Tx , max}^{STA} \} + \hat{PL} ( {m}_{2} , M + 1 ) .$$

Otherwise, it may perform uplink transmission to STA m₂.

### Step 4: Determining the Infrastructure and P2P Transmission Parameters [Option 3]

In option 3, for each coordination window, an independent decision can be made for performing transmission as per option 1 or option 2. This negotiation/decision can be indicated in Step 3 by the AP. The decision can be made based on whichever of the two options can give the highest estimated sum-throughput (i.e., Infrastructure rate+P2P rate) for the given network parameters. For example, let the best selected infrastructure STA for transmission (in either of uplink or downlink) as per Option 1 be STA m₁ and let the achievable signal-to-interference ratio for infrastructure and the P2P for this selected user be SIR_{Infra}⁽¹⁾(m₁) and SIR_{P2P}⁽¹⁾(m₁). Then an SIR-to-MCS mapping table can be used to map the SIR values to an equivalent MCS and then an equation can be used to convert the MCS to an estimated throughput. For example, the SIR-to-MCS mapping table can be:

| SINR | | | | | | | | | | | | |
|---|---|---|---|---|---|---|---|---|---|---|---|---|
| min (dB) | 2 | 5 | 9 | 11 | 15 | 18 | 20 | 25 | 29 | 31 | 35 | 36 |
| MCS | 0 | 1 | 2 | 3 | 4 | 5 | 6 | 7 | 8 | 9 | 10 | 11 |
| index | | | | | | | | | | | | |

and the estimated throughput value can be obtained as:

$$Throughput = \frac{\begin{matrix}Number of Subcarriers \times Bits \\ per Modulation Symbol \times Code Rate\end{matrix}}{OFDM Symbol Duration + Guard Interval Duration}$$

where the ‘Bits per Modulation Symbol’ and ‘Code Rate’ are obtained from the MCS index. Thus, using the equations above we can obtain estimated throughputs for Option 1 as: T_{Infra}⁽¹⁾(m₁) and T_{P2P}⁽¹⁾(m₁). Similarly let the best user selected for option 2 be m₂. A similar set of estimated throughputs can be obtained as: T_{Infra}⁽²⁾(m₂) and T_{Infra}⁽²⁾(m₂). Then for any coordination window, a decision to operate as per Option 1 can be made if:

$${T}_{Infra}^{( 1 )} ( {m}_{1} ) + {T}_{P 2 P}^{( 1 )} ( {m}_{1} ) \geq {T}_{Infra}^{( 2 )} ( {m}_{2} ) + {T}_{P 2 P}^{( 2 )} ( {m}_{2} ) .$$

Otherwise, the AP may determine to operate as per Option 1 in the coordination window.

### Step 5: Altering the Negotiation

The P2PL or the AP may alter one or more of the parameters for a prior negotiation for simultaneous channel access by transmitting a frame to the AP or P2PL, respectively. In one embodiment, the frame can be same as the one used for negotiation, e.g., the P2P Simultaneous Tx Setup frame, or the TWT Setup frame. To indicate that the frame is for updating the parameters of a prior negotiation, an identifier corresponding to the negotiation can be used. For example, this ID can be the TWT Flow Identifier, Broadcast TWT ID or the Dialog Token of the frame used for negotiation of the parameters.

### Step 6: Terminating the Negotiation

FIG. 11 illustrates an example of the P2P Simultaneous Tx Teardown frame 1100 according to embodiments of the present disclosure. The embodiment of the example of the P2P Simultaneous Tx Teardown frame 1100 shown in FIG. 11 is for illustration only. Other embodiments of the example of the P2P Simultaneous Tx Teardown frame 1100 could be used without departing from the scope of this disclosure.

To terminate an active negotiation for simultaneous channel access, the P2PL or AP may transmit a frame indicating the termination. In one embodiment, the frame can be same as the one used for negotiation, e.g., the P2P Simultaneous Tx Setup frame. In this case, there can be a field indicating that the frame is for tearing down a negotiation and some of the other subfields like the P2P Coordination parameters element or TWT element can be missing. In another embodiment, a separate frame can be used for termination, e.g., a P2P Simultaneous Tx Teardown frame, or a the TWT Teardown frame. The frame can have:
A Number Of Negotiations field indicating the number of negotiations being torn down.
A Dialog Token list indicating the Dialog Tokens corresponding to all the negotiations being torn down.
An All Negotiations subfield to indicate that all the existing negotiations are being torn down.

An example illustration of the P2P Simultaneous Tx Teardown frame is depicted in FIG. 11.

In one variant of this embodiment, the proposed negotiations above for simultaneous transmission can also be used for multi-AP coordination between two APs, to allow simultaneous transmissions in the two BSSs.

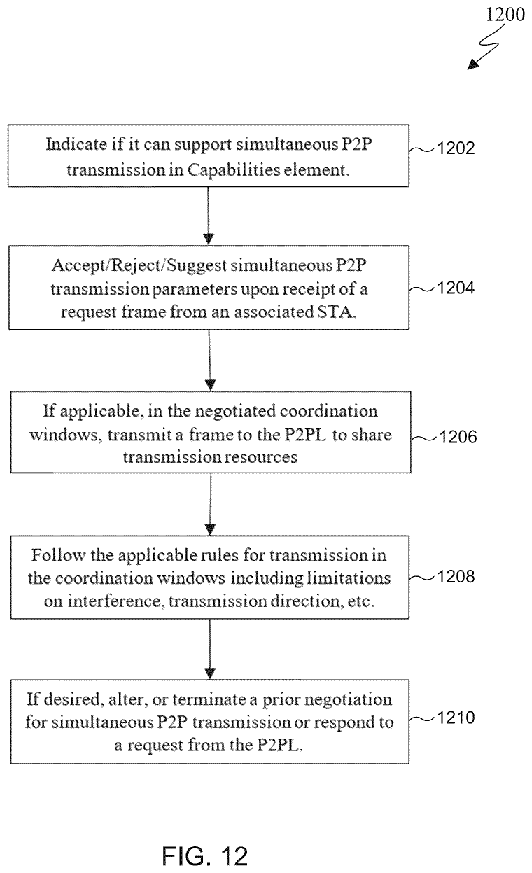

FIG. 12 illustrates an example flow diagram illustrating a method 1200 performed by an AP for enabling simultaneous transmission with P2P traffic according to embodiments of the present disclosure. The embodiment of the method 1200 illustrating the sequence of steps performed by an AP for enabling simultaneous transmission with P2P traffic shown in FIG. 12 is for illustration only. Other embodiments of the example method 1200 illustrating the sequence of steps performed by an AP for enabling simultaneous transmission with P2P traffic could be used without departing from the scope of this disclosure.

As illustrated in FIG. 12, the method 1200 begins at step 1202, where the AP indicates if it can support simultaneous P2P transmission in the Capabilities element. At step 1204, the AP accepts/rejects/suggests simultaneous P2P transmission parameters upon receipt of a request frame from an associated STA. At step 1206, the AP, if applicable, in the negotiated coordination windows, transmits a frame to the P2PL to share transmission resources. At step 1208, the AP follows the applicable rules for transmission in the coordination windows including limitations on interference, transmission direction, etc. At step 1210, the AP alters, or terminates a prior negotiation for simultaneous P2P transmission or responds to a request from the P2PL.

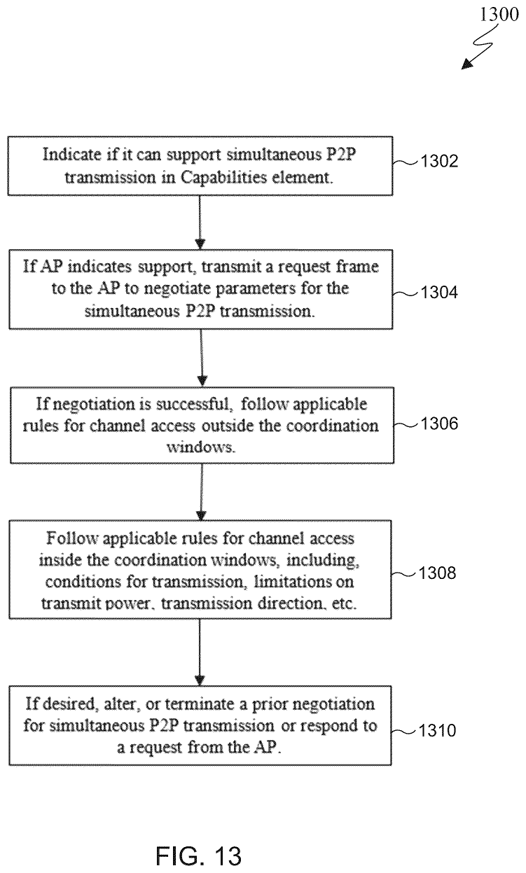

FIG. 13 illustrates an example flow diagram illustrating a method 1300 performed by a non-AP STA (that is a P2P leader) to negotiate for the simultaneous transmissions of its P2P traffic with the infrastructure traffic according to embodiments of the present disclosure. The embodiment of the example method 1300 illustrating the sequence of steps performed by a non-AP STA (that is a P2P leader) to negotiate for the simultaneous transmissions of its P2P traffic with the infrastructure traffic shown in FIG. 13 is for illustration only. Other embodiments of the example method 1300 illustrating the sequence of steps performed by a non-AP STA (that is a P2P leader) to negotiate for the simultaneous transmissions of its P2P traffic with the infrastructure traffic could be used without departing from the scope of this disclosure.

As illustrated in FIG. 13, the method 1300 begins at step 1302, where the STA indicates if it can support simultaneous P2P transmission in the Capabilities element. At step 1304, if the AP indicates support, transmits a request frame to the AP to negotiate parameters for the simultaneous P2P transmission. At step 1306, the STA, if the negotiation is successful, follows applicable rules for channel access outside the coordination windows. At step 1308, the STA follows applicable rules for channel access inside the coordination windows, including, conditions for transmission, limitations on transmit power, transmission direction, etc. At step 1310, the STA alters, or terminates a prior negotiation for simultaneous P2P transmission or responds to a request from the AP.

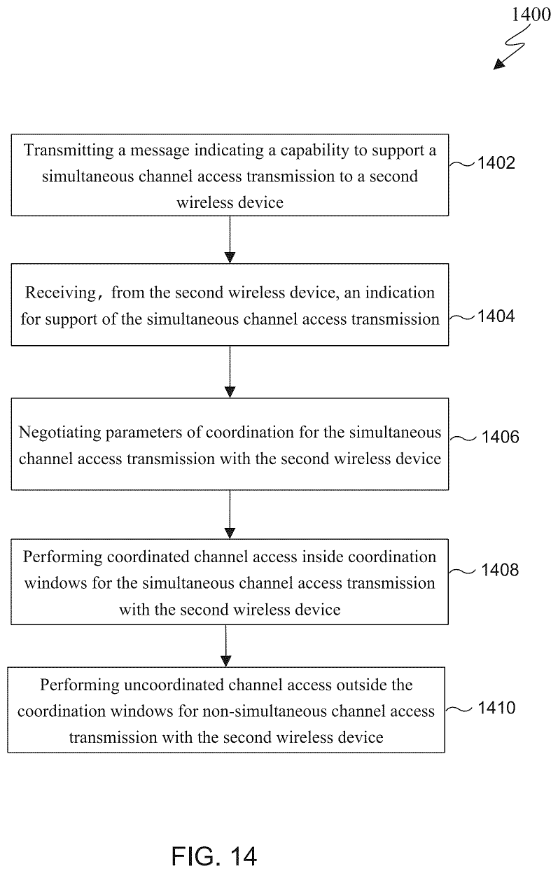

FIG. 14 illustrates a flow diagram of a method 1400 for wireless communication performed by a first wireless device according to embodiments of the present disclosure. The example method 1400 shown in FIG. 14 is for illustration only. Other embodiments of the example method 1400 could be used without departing from the scope of this disclosure.

As illustrated in FIG. 14, the method 1400 begins at step 1402, where the first wireless device transmits a message indicating a capability to support a simultaneous channel access transmission to a second wireless device. At step 1404, the first wireless device receives, from the second wireless device, an indication for support of the simultaneous channel access transmission. At step 1406, the first wireless device negotiates parameters of coordination for the simultaneous channel access transmission with the second wireless device. At step 1408, the first wireless device performs coordinated channel access inside coordination windows for the simultaneous channel access transmission with the second wireless device. At step 1410, the first wireless device performs uncoordinated channel access outside the coordination windows for non-simultaneous channel access transmission with the second wireless device.

In one embodiment, the first wireless device is a member of a first inter-connected network, and the second wireless device comprises an AP associated with a second inter-connected network.

In one embodiment, to negotiate the parameters of coordination, the first wireless device receives a message from the second wireless device with an indication of: an identifier of the negotiation being performed, a result of the negotiation being an accept, reject, or a rejection with suggestion of alternate parameters, a maximum interference level that can be tolerated by the second inter-connected network network within the coordination windows, types of transmissions by the second inter-connected network within the coordination window over which simultaneous transmission is allowed, and other parameters for simultaneous use of a transmission opportunity (TXOP) during the coordination windows.

In one embodiment, coordinated transmission within a coordination window of the coordination windows is initiated by transmission of a message from the second wireless device with an indication of: allocated time and frequency resources for transmission by the first inter-connected network within the coordination window, type of transmissions that are allowed by devices of the first inter-connected network within the coordination window, an interference level that will be generated by the second inter-connected network to devices of the first inter-connected network within the coordination window, a maximum transmit power that can be used by the first inter-connected network within the coordination window, channel sensing parameters to be used by the first inter-connected network within the coordination window, and any changes to the parameters of coordination negotiated between the first wireless device and the second wireless device during the negotiation.

In one embodiment, to perform the coordinated channel access inside the coordination windows, the first wireless device coordinates transmission of devices within the first inter-connected network to access the channel with applicable constraints; and coordinates transmission of devices within the second inter-connected network to access the channel with applicable constraints.

In one embodiment, the constrained coordinated transmission within the coordination windows by each of the first inter-connected group and the second inter-connected group comprises selection of transmitting devices, resource allocations to the transmitting devices, and transmit powers and modulation and coding schemes that comply with the negotiated parameters of coordination.

In one embodiment, to negotiate the parameters of coordination, the first wireless device transmits a message with an indication of: an identifier of the negotiation being performed, a periodicity and duration of the coordination windows, required resources by the first inter-connected network within the coordination windows, a transmit power to be used by devices of the first inter-connected network within the coordination windows, a maximum interference level that can be tolerated by the first inter-connected network within the coordination windows, link identifiers corresponding to links where the negotiated parameters are applicable, a direction of transmissions uplink, downlink or bidirectional that are allowed within the coordination windows, and other parameters for simultaneous use of a transmission opportunity (TXOP) during the coordination windows.

In one embodiment, the first wireless device alters one or more of the parameters of coordination for a prior negotiation for simultaneous channel access transmission; or terminates the prior negotiation for simultaneous channel access transmission.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method of wireless communication performed by a first wireless device, the method comprising:
transmitting a message indicating a capability to support a simultaneous channel access transmission to a second wireless device;
receiving, from the second wireless device, an indication for support of the simultaneous channel access transmission;
negotiating parameters of coordination for the simultaneous channel access transmission with the second wireless device;
performing coordinated channel access inside coordination windows for the simultaneous channel access transmission with the second wireless device; and
performing uncoordinated channel access outside the coordination windows for non-simultaneous channel access transmission with the second wireless device.

2. The method of claim 1, wherein:
the first wireless device is a member of a first inter-connected network, and
the second wireless device comprises an access point (AP) associated with a second inter-connected network.

3. The method of claim 2, wherein negotiating the parameters of coordination further comprises reception of a message from the second wireless device with an indication of:
an identifier of the negotiation being performed,
a result of the negotiation being an accept, reject, or a rejection with suggestion of alternate parameters,
a maximum interference level that can be tolerated by the second inter-connected network within the coordination windows,
types of transmissions by the second inter-connected network within the coordination window over which simultaneous transmission is allowed, and
other parameters for simultaneous use of a transmission opportunity (TXOP) during the coordination windows.

4. The method of claim 2, wherein coordinated transmission within a coordination window of the coordination windows is initiated by transmission of a message from the second wireless device with an indication of:
allocated time and frequency resources for transmission by the first inter-connected network within the coordination window,
type of transmissions that are allowed by devices of the first inter-connected network within the coordination window,
an interference level that will be generated by the second inter-connected network to devices of the first inter-connected network within the coordination window,
a maximum transmit power that can be used by the first inter-connected network within the coordination window,
channel sensing parameters to be used by the first inter-connected network within the coordination window, and
any changes to the parameters of coordination negotiated between the first wireless device and the second wireless device during the negotiation.

5. The method of claim 2, wherein performing the coordinated channel access inside the coordination windows comprises:
coordinating transmission of devices within the first inter-connected network to access the channel with applicable constraints; and
coordinating transmission of devices within the second inter-connected network to access the channel with applicable constraints.

6. The method of claim 5, wherein the constrained coordinated transmission within the coordination windows by each of the first inter-connected network and the second inter-connected network comprises selection of transmitting devices, resource allocations to the transmitting devices, and transmit powers and modulation and coding schemes that comply with the negotiated parameters of coordination.

7. The method of claim 1, wherein negotiating the parameters of coordination further comprises transmission of a message by the first wireless device with an indication of:
an identifier of the negotiation being performed,
a periodicity and duration of the coordination windows,
required resources by a first inter-connected network within the coordination windows,
a transmit power to be used by devices of the first inter-connected network within the coordination windows,
a maximum interference level that can be tolerated by the first inter-connected network within the coordination windows,
link identifiers corresponding to links where the negotiated parameters are applicable,
a direction of transmissions uplink, downlink or bidirectional that are allowed within the coordination windows, and
other parameters for simultaneous use of a transmission opportunity (TXOP) during the coordination windows.

8. The method of claim 1, further comprising:
altering one or more of the parameters of coordination for a prior negotiation for simultaneous channel access transmission; or
terminating the prior negotiation for simultaneous channel access transmission.

9. A first wireless device comprising:
a transceiver; and
a processor operably coupled to the transceiver, the processor configured to:
transmit a message indicating a capability to support a simultaneous channel access transmission to a second wireless device;
receive, from the second wireless device, an indication for support of the simultaneous channel access transmission;
negotiate parameters of coordination for the simultaneous channel access transmission with the second wireless device;
perform coordinated channel access inside coordination windows for the simultaneous channel access transmission with the second wireless device; and
perform uncoordinated channel access outside the coordination windows for non-simultaneous channel access transmission with the second wireless device.

10. The first wireless device of claim 9, wherein:
the first wireless device is a member of a first inter-connected network, and
the second wireless device comprises an access point (AP) associated with a second inter-connected network.

11. The first wireless device of claim 10, wherein to negotiate the parameters of coordination, the processor is further configured to receive a message from the second wireless device with an indication of:
an identifier of the negotiation being performed,
a result of the negotiation being an accept, reject, or a rejection with suggestion of alternate parameters,
a maximum interference level that can be tolerated by the second inter-connected network within the coordination windows,
types of transmissions by the second inter-connected network within the coordination windows over which simultaneous transmission is allowed, and
other parameters for simultaneous use of a transmission opportunity (TXOP) during the coordination windows.

12. The first wireless device of claim 10, wherein coordinated transmission within a coordination window of the coordination windows is initiated by transmission of a message from the second wireless device with an indication of:
allocated time and frequency resources for transmission by the first inter-connected network within the coordination window,
type of transmissions that are allowed by devices of the first inter-connected network within the coordination window,
an interference level that will be generated by the second inter-connected network to devices of the first inter-connected network within the coordination window,
a maximum transmit power that can be used by the first inter-connected network within the coordination window,
channel sensing parameters to be used by the first inter-connected network within the coordination window, and
any changes to the parameters of coordination negotiated between the first wireless device and the second wireless device during the negotiation.

13. The first wireless device of claim 10, wherein to perform the coordinated channel access inside the coordination windows, the processor is further configured to:
coordinate transmission of devices within the first inter-connected network to access the channel with applicable constraints; and
coordinate transmission of devices within the second inter-connected network to access the channel with applicable constraints.

14. The first wireless device of claim 13, wherein to coordinate transmission of devices within each of the first inter-connected network and the second inter-connected network, the processor is further configured to select transmitting devices, resource allocations to the transmitting devices, and transmit powers and modulation and coding schemes that comply with the negotiated parameters of coordination.

15. The first wireless device of claim 9, wherein to negotiate the parameters of coordination, the processor is further configured to transmit a message with an indication of:
an identifier of the negotiation being performed,
a periodicity and duration of the coordination windows,
required resources by a first inter-connected network within the coordination window,
a transmit power to be used by devices of the first inter-connected network within the coordination windows,
a maximum interference level that can be tolerated by the first inter-connected network within the coordination windows,
link identifiers corresponding to links where the negotiated parameters are applicable,
a direction of transmissions uplink, downlink or bidirectional that are allowed within the coordination windows, and
other parameters for simultaneous use of a transmission opportunity (TXOP) during the coordination windows.

16. The first wireless device of claim 9, wherein the processor is further configured to:
alter one or more of the parameters of coordination for a prior negotiation for simultaneous channel access transmission; or
terminate the prior negotiation for simultaneous channel access transmission.

17. An access point (AP) associated with a second inter-connected network, the AP comprising:
a transceiver; and
a processor operably coupled to the transceiver, the processor configured to:
receive a message indicating a capability to support a simultaneous channel access transmission from a first wireless device, wherein the first wireless device is a member of a first inter-connected network;
transmit, to the first wireless device, an indication for support of the simultaneous channel access transmission;
negotiate parameters of coordination for the simultaneous channel access transmission with the first wireless device;
perform coordinated channel access inside coordination windows for the simultaneous channel access transmission with the first wireless device; and
perform uncoordinated channel access outside the coordination windows for non-simultaneous channel access transmission with the first wireless device.

18. The AP of claim 17, wherein to negotiate the parameters of coordination, the processor is further configured to transmit a message to the first wireless device with an indication of:
an identifier of the negotiation being performed,
a result of the negotiation being an accept, reject, or a rejection with suggestion of alternate parameters,
a maximum interference level that can be tolerated by the second inter-connected network within the coordination windows,
types of transmissions by the second inter-connected network within the coordination windows over which simultaneous transmission is allowed, and
other parameters for simultaneous use of a transmission opportunity (TXOP) during the coordination windows.

19. The AP of claim 17, wherein coordinated transmission within a coordination window of the coordination windows is initiated by transmission of a message from the AP to the first wireless device with an indication of:
allocated time and frequency resources for transmission by the first inter-connected network within the coordination window,
type of transmissions that are allowed by devices of the first inter-connected network within the coordination window,
an interference level that will be generated by the second inter-connected network to devices of the first inter-connected network within the coordination window,
a maximum transmit power that can be used by the first inter-connected network within the coordination window,
channel sensing parameters to be used by the first inter-connected network within the coordination window, and
any changes to the parameters of coordination negotiated between the first wireless device and a second wireless device during the negotiation.

20. The AP of claim 17, wherein to perform the coordinated channel access inside the coordination windows, the processor is further configured to:
coordinate transmission of devices within the first inter-connected network to access the channel with applicable constraints; and
coordinate transmission of devices within the second inter-connected network to access the channel with applicable constraints.
